(19) United States
(12) Patent Application Publication
(10) Pub. No.: US 2024/0384020 A1
(43) Pub. Date: Nov. 21, 2024

(54) NONIONIC RESINS AND THEIR USES IN STAIN BLOCKING ARCHITECTURAL COMPOSITIONS

(71) Applicant: Columbia Insurance Company, Omaha, NE (US)

(72) Inventors: Ajaya Nanda, Flanders, NJ (US); Yong Yang, Hillsborough, NJ (US); Richard Geurtsen, Robbinsville, NJ (US); Xinyu Wang, Hillsborough, NJ (US)

(21) Appl. No.: 18/689,659

(22) PCT Filed: Jul. 10, 2023
(86) PCT No.: PCT/US2023/027257

§ 371 Date: Mar. 6, 2024

Related U.S. Application Data
(60) Provisional application No. 63/388,080, filed on Jul. 11, 2022.

(51) Int. Cl. C08F 220/18; C08F 220/14; C09D 133/08; C09D 133/12

(52) U.S. Cl. CPC C08F 220/1804; C08F 220/14; C09D 133/08; C09D 133/12

(57) ABSTRACT

Disclosed herein are a stable nonionic resin composition that is compatible with a cationic resin composition, and blends of the nonionic resin and cationic resin. Primer and topcoat paint compositions containing such blends are resistant to stains migrating to the top of the paint films.

### FIELD OF THE INVENTION

The present invention relates to nonionic resins and their uses in low VOC, waterborne, stain blocking architectural compositions, including but are not limited to, primer or top-coat paint compositions that include cationic resin(s) or cationic additive(s).

### BACKGROUND OF THE INVENTION

Certain substrates to be painted such as woods have tannins, which are astringent, polyphenolic biomolecules, which can bleed through paint films including the primer paint layer and stain the topcoat paint layer becoming undesirable visible stains on the painted substrates. Other stains include crayons, lipsticks, marker pens, coffee, wine etc. and other stains on walls, and water dripping stains on ceilings that can bleed through paint films.

Conventional solvent-based alkyd coatings are capable of blocking of stains, but have odor and high volatile organic component (VOC) emissions. Hydrophobic waterborne acrylic resins have been used to block stains by creating hydrophobic paint film layers. In these hydrophobic waterborne systems, stains would still bleed into the primer layer, and would eventually bleed into the topcoats.

Most stains are anionic in nature and can be locked from migrating by cationic resins in waterborne architectural compositions. Cationic resins limit the mobility of the water-soluble stains in waterborne coating applications. The cationic resins form complexes with the anionic stains in an ion exchange content to render the stains insoluble and trapped or locked in the primer paint film when it dries. However, cationic resins are generally highly hydrophilic and could increase the water sensitivity of the architectural compositions and paint films. Increased water sensitivity in cationic coatings can cause loss of wet adhesion, scrub resistance and blistering resistance.

As discussed in U.S. Pat. No. 5,312,863, conventional aqueous latex coatings are generally anionic. The anionic latex polymer binders are generally prepared by aqueous emulsion polymerization techniques using non-ionic and/or anionic surfactants. These anionic latex polymer binders are blended with opacifying pigments, extender pigments and dispersed with anionic pigment dispersants to form waterborne latex coatings or paints. The anionic binders typically contain anionic functional groups such as a and carboxylate groups. Functionalization of these anionic latex polymers with amines, acetoacetate or amides such as ethylene urea derivatives can improve wet adhesion to substrates. The '863 patent and references cited therein are incorporated by reference in their entireties.

However, heretofore cationic resins are not blended or mixed with anionic resins to alleviate the water sensitivity issues associated with cationic resins. Blending or mixing cationic resins with anionic resins would readily cause grit formulation or gelation and in general loss of performance and physical properties.

Hence, there remains a need for waterborne formulations that have improved stain resistance and that can resist stains from the substrate from migrating to the topcoats while minimizing the water sensitivity of the paint films. More specifically, such stain resistant formulations utilize the stain locking ability of cationic resins while mitigating their incompatibility when blended with nonionic resins to mitigate or prevent the formation of grit or gel.

### SUMMARY OF THE INVENTION

Hence, the invention is directed to novel waterborne architectural compositions that pair cationic resins that lock stains, with novel nonionic resins that minimize or remedy the cationic resins' water sensitivity. The inventive nonionic resins are stable and compatible with the cationic resins, i.e., the inventive nonionic resins do not form grit or gel when blended with cationic resins.

In one embodiment of the present invention, the cationic resin provides the stain locking ability and the non-ionic resin enhances film formation and adhesion to substrates. Preferably, the inventive nonionic resin is free or substantially free of acid monomers, such as monomers with carboxylic acid, and is free or substantially free of all monomers with anionic groups, such as monomers with phosphate, sulfonate, and other monomers with anionic charge. As used herein, substantially free of acid monomers means that low levels of less than 0.25 wt. %, preferably less than 0.125 wt. % of total monomer content. Preferably, the inventive nonionic resins contain no acid monomer.

Without being bound to any particular theory, the present inventors have discovered that polymerization, preferably emulsion polymerization, could be conducted without acid monomer(s) when the nonionic surfactant(s) used to seed or form micelles have a high hydrophilic-lipophilic balance (HLB) value from about 14 to about 18, preferably about 14 to about 17, preferably from about 15 to about 18. Nonionic surfactants may range from about 1 wt. % to 8 wt. %, preferably from about 5 wt. % to 7 wt. %, preferably from about 5.5 wt. % to 6.5 wt. %. In preferred embodiments, the only surfactants used in the polymerization are nonionic surfactants, except as discussed below.

The non-ionic surfactants have high HLB values. Without being bound to any particular theory, higher hydrophilicity is needed to stabilize the latex particles, because there is no static stabilization due to the non-ionic nature of these latexes.

In some embodiments, a small amount of an anionic surfactant can be substituted for nonionic surfactant in the seeding stage at the beginning of the polymerization to better control particle size of the seed formation. The total amount of anionic surfactant can be from 0 wt. % to about 0.25 wt. %, preferably 0.01 wt. % to about 0.25 wt. %, preferably from about 0.035 wt. % to about 0.15 wt. %, preferably from about 0.05 wt. % to about 0.15 wt. % based on total monomer content. Without being bound to any particular theory, the present inventors believe that anionic surfactants are more efficient at controlling particle size, and at low levels anionic surfactants are compatible with latex and cationic paints.

In another embodiment, an optional polymerizable hydrophilic component, such as a polymerizable ethylene oxide or propylene oxide, is copolymerized to form the inventive nonionic resin. The hydrophilic moiety on the nonionic resin provides additional attraction for water in the waterborne resin compositions or architectural compositions to mitigate or minimize coagulation. The polymerizable hydrophilic component is present from 0 wt. % to about 10 wt. %, from 0 wt. % to about 5 wt. %, or from about 1.0 wt. % to about 4.0 wt. %, or from about 1.5 wt. % to about 3.5 wt. %. In one preferred embodiment, the polymerizable hydrophilic component is omitted, i.e., present at 0 wt. %.

It is noted that when polymerizable hydrophilic component is included in the monomer mixture to be copolymerized, the amount of nonionic surfactant needed for the polymerization can be reduced to the lower portion of the 1 wt. % to 8 wt. %, discussed above. In such cases, the nonionic surfactant ranges from about 1 wt. % to about 3.5 wt. %, or from about 1 wt. % to about 3.0 wt. %.

The percentages for the components of the nonionic resin, described herein, are given as weight percentages of the active ingredients including the weight of the solid monomers and active ingredients of the additives, excluding water.

In another embodiment, the waterborne paint compositions that incorporate blend of the inventive nonionic resin and a cationic resin also include a rust inhibitor to minimize or prevent rust formation in metal paint cans. For primer paint compositions which can be applied on substrates including metal substrates, flash rust inhibitor is preferred. Also, an organic flash rust inhibitors are preferred due to their efficiency and compatibility.

An embodiment of the present invention is directed to a substantially nonionic latex resin composition polymerized from
a monomer mixture comprising at least one nonionic (meth)acrylate monomer, wherein the monomer mixture is substantially free of acid monomer or other monomers with anionic groups, and
a nonionic surfactant ranging from about 4 wt. % to 8 wt. %, preferably from about 5 wt. % to 7 wt. %, preferably from about 5.5 wt. % to 6.5 wt. %,
wherein the nonionic surfactant has a hydrophilic-lipophilic balance (HLB) value from about 14 to about 18, preferably about 14 to about 17, preferably from about 15 to about 18,
wherein the weight percentages are without water.

The substantially nonionic latex resin composition can be additionally polymerized with an anionic surfactant in a seeding amount ranging from 0 wt. % to about 0.25 wt. %, preferably 0.01 wt. % to about 0.25 wt. %, preferably from about 0.05 wt. % to about 0.15 wt. % based on total monomer content.

The monomer mixture comprises no acid monomer or other monomers with anionic groups, or the acid monomer or other monomers with anionic groups are less than 0.25 wt. %, preferably less than 0.125 wt. % of total monomer content.

The monomer mixture may further comprise a polymerizable nonionic hydrophilic component, wherein the polymerizable nonionic hydrophilic component is preferably present from 0 wt. % to about 10 wt. %, from 0 wt. % to about 5 wt. %, from about 1.0 wt. % to about 4.0 wt. %, or from about 1.5 wt. % to about 3.5 wt. %.

The polymerizable hydrophilic component comprises a polymerizable polyethylene glycol monomer or a polymerizable polypropylene glycol monomer. The polymerizable polyethylene glycol monomer is preferably a methoxypolyethylene glycol methacrylate monomer.

In one embodiment, only nonionic surfactant is used in the polymerization to form micelles and the substantially nonionic latex resin.

Another embodiment of the present invention is directed to a paint composition, preferably a primer paint or topcoat composition, comprising a blend of the substantially nonionic latex resin composition of claim 1 and a cationic resin.

The paint composition may further comprise a rust inhibitor.

The blend of inventive nonionic resin and cationic resin ranges
a. from 80 wt. % cationic resin and 20 wt. % nonionic resin to 20 wt. % cationic resin and 80 wt. % nonionic resin,
b. from 70 wt. % cationic resin and 30 wt. % nonionic resin to 30 wt. % cationic resin and 70 wt. % nonionic resin,
c. from 60 wt. % cationic resin and 40 wt. % nonionic resin to 40 wt. % cationic resin and 60 wt. % nonionic resin, or
d. from 55 wt. % cationic resin and 45 wt. % nonionic resin to 45 wt. % cationic resin and 55 wt. % nonionic resin,
e. wherein the wt. % of cationic resin and nonionic resins are dry weight.

As used in the present invention, “substantially nonionic latex resins” mean nonionic latex resins that are substantially free of acid monomers or monomers with anionic group, and that may include a seeding amount of anionic surfactant used in the seeding phase of the polymerization process to control particle size of the latex resin, as those terms are defined and used herein throughout. Preferably, no acid monomers and no monomers with anionic group are used in the polymerization of nonionic resin.

### DETAILED DESCRIPTION OF THE PREFERRED EMBODIMENTS

While capable of locking up stains and minimizing the stains' ability to migrate through the paint films, cationic resins can cause water sensitivity problems, such as loss of wet adhesion, decreasing scrub resistance and reduced resistance to blisters. The present invention resolves this problem by blending a cationic resin with a novel stable nonionic resin. The inventive stable nonionic resin compositions are advantageously compatible with cationic resins and do not form grit or gel when blended with the cationic resins.

U.S. Pat. No. 4,981,759 discloses that nonionic acrylic resins may be obtained by (co)polymerizing at least one unsaturated monomer selected according to the properties required from alkyl (meth)acrylates such as methyl (meth)acrylate, ethyl (meth)acrylate, butyl (meth)acrylate, propyl (meth)acrylate and 2-ethylhexyl (meth)acrylate; hydroxyalkyl (meth)acrylates such as hydroxyethyl (meth)acrylate and hydroxypropyl (meth)acrylate; (meth)acrylic acid; aromatic vinyl compounds such as styrene and its derivatives (e.g., alpha-methylstyrene); (meth)acrylonitrile; and butadiene.

Typical emulsion polymerization such as those described in the '759 patent includes acrylic, vinyl or styrene monomers, and a small amount of acid monomers, such as (meth)acrylic acid, is added to stabilize the polymerization. Generally, without the acid monomer(s) the emulsion processes are not stable and are often not successful. The present inventors have determined that having acid monomers, such as (meth)acrylic acid in the polymerization would render the resulting polymers anionic. Without being bound to any particular theory it is believed that the side chains on the (meth)acrylic acid in the latex polymer lose proton(s) and become anionic.

In one preferred embodiment of the present invention, acid monomers are omitted or substantially omitted from the polymerization to prevent these moieties on the polymer from becoming anionic. To impart stability to the nonionic polymeric resin, a hydrophilic and nonionic surfactant having relatively high HLB value is utilized in the polymerization to seed or form micelles. A polymerizable nonionic hydrophilic component, such as a polyethylene glycol or polypropylene glycol (e.g., a methoxypolyethylene glycol methacrylate (MW of 750 Daltons in 50% in water)) can be optionally added to the polymerization. In order to control the particle size of the latex resin, a small amount of an anionic surfactant is optionally utilized in the polymerization at the seeding stage. This anionic surfactant, if used, is preferably the only ionic component in the polymerization and is efficient in seeding the latex polymer.

Acid monomer(s) is preferably held to less than 0.25 wt. %, preferably less than 0.125 wt. %, and preferably less than 0.1 wt. % and more preferably 0 wt. %.

The nonionic surfactant(s) range from about 4 wt. % to 8 wt. %, preferably from about 5 wt. % to 7 wt. %, preferably from about 5.5 wt. % to 6.5 wt. %, and the nonionic surfactant has a hydrophilic-lipophilic balance (HLB) value from about 14 to about 18, preferably about 14 to about 17, preferably from about 15 to about 18.

The optional anionic surfactant is preferably present from 0 wt. % to about 0.25 wt. %, preferably 0.01 wt. % to about 0.25 wt. %, preferably from about 0.035 wt. % to about 0.15 wt. %, preferably from about 0.05 wt. % to about 0.15 wt. %.

The optional nonionic polymerizable hydrophilic component is preferably present from 0 wt. % to about 10 wt. %, from 0 wt. % to about 5 wt. %, or from about 1.5 wt. % to about 3.5 wt. %. The nonionic polymerizable hydrophilic component can also be from about 1.0 wt. % to about 4.0 wt. %. The nonionic polymerizable hydrophilic component can be omitted.

The percentages for the non-ionic resin described herein are given as weight percentages of the active ingredients including the weight of the solid monomers and active ingredients of the additives, excluding water.

An exemplary composition of the inventive nonionic resin without acid monomer is shown below in Example 1. The weight percentages reported in this Example do not include water. Typically, MPEG 750 MA is available in a 50% aqueous solution, and the (meth)acrylate monomers are available as 40-42 wt. % solids in aqueous solutions.

### Example 1

| | |
|---|---|
| Materials | Weight % |

Buffer

| | |
|---|---|
| Sodium bicarbonate | 0.12 |

Surfactants

| | |
|---|---|
| Nonionic surfactant | 2.86 |
| Anionic surfactant -- ammonium | 0.05 |
| phosphate, polyoxyethylene | |
| tridecyl ether | |

Monomers

| | |
|---|---|
| methoxypolyethylene glycol | 2.76 |
| methacrylate (MPEG 750 MA) | |
| butyl acrylate (BA) | 42.31 |
| methyl methyacrylate (MMA) | 39.33 |
| 2-ethyl hexyl acrylate (2-EHA) | 7.20 |
| acetoacetoxyethyl methacrylate | 4.78 |
| (AAEM) | |

Initiator

| | |
|---|---|
| Sodium Persulfate (Na₂S₂O₈) | 0.22 |

Chaser

| | |
|---|---|
| t-butyl hydroperoxide (tBHp) | 0.13 |
| Bruggolite FF6M | 0.18 |

Biocide

| | |
|---|---|
| Biocide | 0.06 |

The glass transition temperature (Tg) range for the nonionic resin is from about −5° C. to about 5° C., as calculated with Fox's equation with a typical value of 1° C. The minimum film forming temperature (MFFT) ranges from about −2° C. to about 2° C. as determined by ISO 2115 standard. The particle size is from about (mean volume) is about 155 nm to about 175nm, and the pH is about 5 to about 6. The number averaged molecular weight is 70,047 Daltons and the weight averaged molecular weight is 243,139 Daltons, as measured by GPC (RI detector) using polystyrene standards.

Another exemplary composition of the inventive nonionic resin without acid monomer is shown below in Example 2. The weight percentages reported in this Example do not include water. The polymerizable hydrophilic nonionic component, e.g., MPEG, is omitted in this Example (0 wt. %).

### Example 2

| | |
|---|---|
| Materials | Weight % |

Buffer

| | |
|---|---|
| Sodium bicarbonate | 0.12 |

Surfactants

| | |
|---|---|
| Nonionic surfactant | 5.62 |
| Anionic surfactant -- ammonium | 0.06 |
| phosphate, polyoxyethylene | |
| tridecyl ether | |

Monomers

| | |
|---|---|
| methoxypolyethylene glycol | 0.0 |
| methacrylate (MPEG 750 MA) | |
| butyl acrylate (BA) | 38.96 |
| methyl methyacrylate (MMA) | 42.65 |
| 2-ethyl hexyl acrylate (2-EHA) | 7.21 |
| acetoacetoxyethyl methacrylate | 4.79 |
| (AAEM) | |

Initiator

| | |
|---|---|
| Sodium Persulfate (Na₂S₂O₈) | 0.22 |

Chaser

| | |
|---|---|
| t-butyl hydroperoxide (tBHp) | 0.13 |
| Bruggolite FF6M | 0.18 |

Biocide

| | |
|---|---|
| Biocide | 0.06 |

The nonionic surfactant in Example 2 is about two times (2×) that amount in Example 1 at 5.62 wt. % and the polymerizable hydrophilic nonionic component (MPEG) is reduced to zero.

In Example 3, the nonionic surfactant is about 1.5× that amount in Example 1 at about 4.3 wt. %, and the polymerizable hydrophilic nonionic component (MPEG) is reduced to about (½)× that amount in Example 1 at about 1.38 wt. %.

In Paint Example 4, an exemplary paint composition utilizing the inventive nonionic resin in a blend with a commercial cationic resin is shown below. The weight percentages given in Example 4 include water.

### Paint Example 4

| Material | Weight % |
|---|---|
| Water | 13.315 |

Biocide

| | |
|---|---|
| Iodopropynyl butylcarbamate | 0.187 |

Dispersant

| | |
|---|---|
| Non-ionic dispersant | 1.442 |

Opacifying pigment

| | |
|---|---|
| Titanium dioxide | 18.074 |

Extender

| | |
|---|---|
| Aluminum silicate | 9.365 |

Defoamers

| | |
|---|---|
| Polysiloxane | 0.468 |

Flash Rust Inhibitor

| | |
|---|---|
| (benzothiazol-2-ylthio)succinic acid | 0.281 |

pH modifier

| | |
|---|---|
| Potassium Carbonate | 0.15 |

Crosslinker

| | |
|---|---|
| Adipic acid dihydrazide (ADH) slurry | 0.543 |

Resin 1

| | |
|---|---|
| Inventive Nonionic Resin (From Example 1) | 22.166 |

Resin 2

| | |
|---|---|
| Cationic Resin | 31.312 |

Coalescent Aid

| | |
|---|---|
| 2,2,4-Trimethylpentane-1,3-diol | 0.777 |
| monoisobutyrate | |

Surfactant

| | |
|---|---|
| Non-ionic surfactant | 0.234 |

Rheology modifiers

| | |
|---|---|
| HEUR Thickener 1 - ICI Builder | 1.311 |
| HEUR Thickener 2 - KU and low shear | 0.375 |
| builder | |

The cationic resin contains about 57% water and the nonionic resin contains about 59% water. Hence, the ratio of cationic resin to nonionic resin—dry weight—is (0.43×31.312):(0.41×22.166) or 13.46:9.09 or about 59.6:40.4 (or 60:40) cationic to nonionic resin. The total resin amount is about 22.55% of solid resin (dry) in the total formula (including water). The rust inhibitor may range from 0 wt. % to about 1 wt. %, preferably from 0.15 wt. % to 0.5 wt. %.

Paint Example 5 is similar to Paint Example 4 at 60:40 blend, except that the nonionic resin in Example 2 is used. Paint Example 6 is similar to Paint Example 4 at 60:40 blend, except that the nonionic resin in Example 3 is used.

The cationic resin used in these experiments is a commercial waterborne emulsion polymerized resin.

The blends shown in Paint Examples 4-6 do not form grit or gel when being blended and therefore do not negatively affect the performance of the paint film formed by the blends.

In Experiments 7, various dry paint films from different paint/architectural compositions painted over cedar plank surfaces that contain stains were tested. Contrast ratio readings were taken over the stained and unstained areas. Δb* measurements were taken over the stained areas for each paint film. The dry paint films were also inspected for blisters. The results are shown below.

### Experiments 7

| | C/R - | Δb* | |
|---|---|---|---|
| Description of | Primer | (yellowness) | Blistering |
| Tested Paint Compositions | Only | Primer Only | Resistance |
| A. Benchmark:Waterborne | 98.2 | 0.71 | 4 |
| Commercial Primer | | | |
| Paint 4 (1:1 ratio of nonionic | 98.8 | 1.04 | 5 |
| surfactant to MPEG) | | | |
| Paint 5 (2:0 ratio of nonionic | 98.4 | 1.19 | 2 |
| surfactant to MPEG) | | | |
| Paint 6 (1.5:0.5 ratio of nonionic | 99.0 | 0.86 | 2 |
| surfactant to MPEG) | | | |

C/R is the contrast ratio. The contrast ratio is the ratio of the Y value of the paint over the stained region divided by the luminance (Y) value of the paint color over the unstained region. The best C/R score is theoretically 100.
Δb* is the measurements of yellowness by a spectrophotometer to measure the intensity of light at certain wavelengths, e.g., the wavelengths for the color yellow. A higher reading means more stain.
The blistering resistance is tested at 90° C., and scale is 1-5, with 1 being worst.

Experiments 7 show that Paints 4-6 have comparable tannin hiding or locking properties as the bench mark primer paint. The blistering resistance is reduced when the polymerizable hydrophilic nonionic component is reduced or omitted. The present inventors note that the in-house blistering resistance test is rigorously conducted at 90° C., which far exceeds the environment conditions that paints and other architectural compositions would be exposed to. Although, the high pass (5.0 score) of inventive Paint 4 shows that inventive paint' enhanced abilities to resist blisters at high temperatures. The present invention is not limited to any blistering scores. Paints 5 and 6 are within the scope of the present invention by exhibiting good tannin resistant property, and no grit or gel were formed when the cationic and nonionic resins are blended. These paints are commercially acceptable for applications that don't require exposure to such high temperatures.

Preferably, the blend of inventive nonionic resin and cationic resin ranges from 80 wt. % cationic resin and 20 wt. % nonionic resin to 20 wt. % cationic resin and 80 wt. % nonionic resin. The blend may also range from 70 wt. % cationic resin and 30 wt. % nonionic resin to 30 wt. % cationic resin and 70 wt. % nonionic resin. The blend may also range from 60 wt. % cationic resin and 40 wt. % nonionic resin to 40 wt. % cationic resin and 60 wt. % nonionic resin. The blend may also range from 55 wt. % cationic resin and 45 wt. % nonionic resin to 45 wt. % cationic resin and 55 wt. % nonionic resin.

Exemplary “cationic” resins include latex resins that are polymerized with commonly used (meth)acrylic monomers, which include styrene or vinyl acetate, and one or more cationic monomers. One exemplary cationic monomer includes one or more dimethylamino functional monomers, wherein the one or more dimethylamino functional monomers have the following formula:

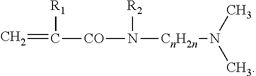

wherein R₁ represents hydrogen or methyl; R₂ represents hydrogen or C1-6 alkyl and n is 2 to 6.

Preferably, the dimethylamino monomers include N,N-dimethylaminoethylmethacrylate (DMAEMA), dimethylaminopropylmethacrylate (DMAPMA) and butylaminoethylmethacrylate (TBAEMA) and N-[3-(dimethylamino)propyl]methacrylamide (DMAPMAA).

Other suitable “cationic” monomers include but are not limited to N,N-dimethylamino ethyl acrylate, N-2-N,N-dimethylamino ethyl methacrylamide, N-3-N,N-dimethylamino propyl acrylamide, N-3-N,N-dimethylamino propyl methacrylamide, N,N-diethylamino ethyl acrylate, N,N-diethylamino ethyl methacrylate, N-t-butylamino ethyl acrylate, N-t-butylamino ethyl methacrylate, N,N-dimethylamino propyl acrylamide, N,N-diethylamino propyl acrylamide, N,N-diethylamino propyl methacrylamide. Other suitable “cationic” monomers are disclosed in US 2014/0121146 (paragraph [0042]), US 2015/0374634 (paragraph [0123]), US 2009/0269406 (paragraph [0034]), U.S. Pat. No. 7,319,117 (cols. 11 and 17). These references are incorporated herein in their entireties.

### Example 4: Preparation of Cationic Acrylic Latex Emulsion Containing 1 wt. % and 3 wt. % DMAPMAA

A process for producing a cationic latex emulsion is described in Example 4. The “cationic” functional monomer DMAPMAA was incorporated into the resin by a semi-continuous MMA/BA emulsion copolymerization process employing a 5-L glass reactor equipped with a mechanical stirrer and a condenser. The reaction temperature was controlled by a water bath. The solution pH was maintained between 8 and 9. DMAPMAA was added to the last 20-50% of pre-emulsion. Pre-emulsions were added at a constant feed rate over a period of 4 hours and an initiator solution was added at a constant feed rate over a period of 4.5 hours. All the polymerizations were carried out at 80° C. at 50% solid content (mass of monomers with respect to total reaction mass). The DMAPMAA monomer makes up about 1% or 3% by weight (or mass) of the total monomers. The copolymer binder can be made with or without 0.1-1% cross-linker.

The particle size of the resulting emulsion is 140-150 nm; non-volatile content was 50-51%. Table 1 describes the non-inventive control and the inventive composition containing the DMAPMAA monomer.

### Compositions of the Acrylic Latex Emulsions With 1% and 3% DMAPMAA

Reagents (grams)

| | 1 wt. % | 3 wt. % |
|---|---|---|
| | DMAPMAA | DMAPMAA |
| Pre-emulsion | Grams | Grams |
| H₂O | 690 | 690 |
| Methyl methacrylate (MMA) | 1030 | 1010 |
| Butyl acrylate (BA) | 910 | 890 |
| Methacrylic acid | 20 | 20 |
| Wet adhesion monomer | 20 | 20 |
| DMAPMAA | 20 | 60 |
| Non-ionic surfactant ‡ | 40 | 40 |
| Reactor Initial Charge | | |
| H₂O | 1000 | 1000 |
| Non-ionic surfactant ‡ | 3 | 3 |
| Initiator Charge | | |
| H₂O | 300 | 300 |
| Free radical initiator † | 4 | 4 |

‡ suitable non-ionic surfactants include Abex ® 2525 available from Rhodia Solvay,
† suitable free radical initiators include 4,4′-Azobis(4-cyanovaleric acid) or C₁₂H₁₆N₄O₄ available from Sigma Aldrich, and sodium persulfate.

Suitable emulsion latex particles include but are not limited to acrylic, vinyl, vinyl-acrylic or styrene-acrylic polymers or copolymers. The latex particles coalesce and/or crosslink to form a paint film on a substrate. Latexes made principally from acrylic monomers are preferred for the present invention, as illustrated in the Examples herewithin. Exemplary, non-limiting monomers suitable to form the emulsion latex particles for the present invention are described below.

Generally, any (meth)acrylic monomers can be used in the present invention. Suitable (meth)acrylic monomers include, but are not limited to methyl (meth)acrylate, ethyl (meth)acrylate, butyl (meth)acrylate, iso-octyl (meth)acrylate, lauryl (meth)acrylate, 2-ethylhexyl (meth)acrylate, stearyl (meth)acrylate, isobornyl (meth)acrylate, methoxyethyl (meth)acrylate, 2-ethyoxyethyl (meth)acrylate, 2-hydroxyethyl (meth)acrylate, 2-hydroxybutyl (meth)acrylate, dimethylamino ethyl (meth)acrylate, diethylaminoethyl (meth)acrylate, dimethylaminopropyl (meth)acrylamide, alkyl (meth)acrylic acids, such as methyl (meth)acrylate acids, (meth)acrylic acids, wet adhesion monomers, such as N-(2-methacryloyloxyethyl)ethylene urea, and multifunctional monomers such as divinyl benzene, diacrylates, for crosslinking functions etc., acrylic acids, ionic acrylate salts, alkacrylic acids, ionic alkacrylate salts, haloacrylic acids, ionic haloacrylate salts, acrylamides, alkacrylamides, monoalkyl acrylamides, monoalkyl alkacrylamides, alkyl acrylates, alkyl alkacrylates, acrylonitrile, alkacrylonitriles, dialkyl acrylamides, dialkyl alkacrylamides, hydroxyalkyl acrylates, hydroxyalkyl alkacrylates, only partially esterified acrylate esters of alkylene glycols, only partially esterified acrylate esters of non-polymeric polyhydroxy compounds like glycerol, only partially esterified acrylate esters of polymeric polyhydroxy compounds, itaconic acid, itaconic mono and di-esters, and combinations thereof. The preferred alkyl (meth)acrylate monomers are methyl methacrylate and butyl acrylate.

Preferred monomers containing aromatic groups are styrene and α-methylstyrene. Other suitable monomers containing aromatic groups include, but are not limited to, 2,4-diphenyl-4-methyl-1-pentene, 2,4-dimethylstyrene, 2,4,6-trimethylstyrene, 2,3,4,5,6-pentafluorostyrene, (vinylbenzyl)trimethylammonium chloride, 2,6-dichlorostyrene, 2-fluorostyrene, 2-isopropenylaniline, 3(trifluoromethyl)styrene, 3-fluorostyrene, α-methylstyrene, 3-vinylbenzoic acid, 4-vinylbenzyl chloride, α-bromostyrene, 9-vinylanthracene, and combinations thereof.

Preferred monomers containing primary amide groups are (meth)acrylamides. Suitable monomers containing amide groups include, but are not limited to, N-vinylformamide, or any vinyl amide, N,N-dimethyl(meth)acrylamide, N-(1,1-dimethyl-3-oxobutyl)(meth)acrylamide, N-(hydroxymethyl)(meth)acrylamide, N-(3-methoxypropyl)(meth)acrylamide, N-(butoxymethyl)(meth)acrylamide, N-(isobutoxymethyl)acryl(meth)acrylamide, N-[tris(hydroxymethyl)methyl]acryl(meth)acrylamide, 7-[4-(trifluoromethyl)coumarin](meth)acrylamide, 3-(3-fluorophenyl)-2-propenamide, 3-(4-methylphenyl)(meth)acrylamide, N-(tert-butyl)(meth)acrylamide, and combinations thereof. These monomers can be polymerized with acrylic monomers, listed above. General formula for vinyl(form)amides are:

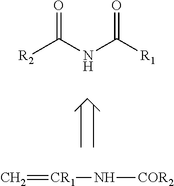

and (meth)acrylamides:

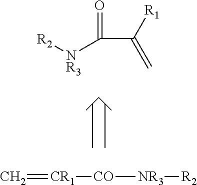

where R1 and R2 can be —H, —CH₃, —CH₂CH₃, and other substituted organic functional groups and R3 can by —H, an alkyl or an aryl.

In one embodiment, styrene monomers, such as styrene, methylstyrene, chlorostyrene, methoxystyrene and the like, are preferably co-polymerized with (meth)acrylamide monomers.

In one embodiment, the aqueous latex polymer may also comprise vinyl monomers. Monomers of this type suitable for use in accordance with the present invention include any compounds having vinyl functionality, i.e., —CH═CH₂ group. Preferably, the vinyl monomers are selected from the group consisting of vinyl esters, vinyl aromatic hydrocarbons, vinyl aliphatic hydrocarbons, vinyl alkyl ethers and mixtures thereof.

Suitable vinyl monomers include vinyl esters, such as, for example, vinyl acetate, vinyl propionate, vinyl laurate, vinyl pivalate, vinyl nonanoate, vinyl decanoate, vinyl neodecanoate, vinyl butyrates, vinyl caproate, vinyl benzoates, vinyl isopropyl acetates and similar vinyl esters; nitrile monomers, such (meth)acrylonitrile and the like; vinyl aromatic hydrocarbons, such as, for example, styrene, methyl styrenes and similar lower alkyl styrenes, chlorostyrene, vinyl toluene, vinyl naphthalene and divinyl benzene; vinyl aliphatic hydrocarbon monomers, such as, for example, vinyl chloride and vinylidene chloride as well as alpha olefins such as, for example, ethylene, propylene, isobutylene, as well as conjugated dienes such as 1,3-butadiene, methyl-2-butadiene, 1,3-piperylene, 2,3-dimethyl butadiene, isoprene, cyclohexene, cyclopentadiene, and dicyclopentadiene; and vinyl alkyl ethers, such as, for example, methyl vinyl ether, isopropyl vinyl ether, n-butyl vinyl ether, and isobutyl vinyl ether.

Additives including surfactants, initiators, chaser solutions, biocides, rheological modifiers, etc. can be added to the polymerization process.

Surfactants are described in “Additives Reference Guide” by J. V. Koleske, R. Springate and D. Brezinski at pp. 83-88 (2013), and these pages are incorporated herein in their entirety. The following discussion of surfactants are based on Koleske et al.

Nonionic surfactants usually refer to polyoxyethylene derivatives although other surfactants are included in this category. They are usually prepared by the addition reaction of ethylene oxide to hydrophobic compounds that contain one or more active hydrogen atoms. Examples of such hydrophobic compounds are fatty alcohols, alkylphenols, fatty acids, fatty amine, alkanolamines, fatty mercaptans, fatty amines and certain polyols. The polyols can include oxypropylene polyols, polyesters, and the like. These surfactants do not carry a charge nor do they dissociate. Their surface-active character comes from the oxyethylene portion of the molecule. Both the nature of the hydrophobe and the length of the oxyethylene chain have an effect on the surface-active character.

Overall, these groups are weakly hydrophilic in comparison to the hydrophobic portion of the molecule. Also present in many nonionic surfactants are weak ester and amide linkages. Nonionic surfactants are generally compatible with ionic surfactants. For example, many nonionic surfactants function well with anionic surfactants. In such combinations, they impart good freeze-thaw stability to aqueous systems and are less deleterious to mechanical properties than the ionic compounds. Nonylphenol ethoxylate (NPE) is a typical example of such surfactants. Other examples are: octylphenol ethoxylates (OPE), secondary alcohol ethoxylates, trimethyl nonanol ethoxylates (TMN), specialty alkoxylates, and amine ethoxylates. In emulsion polymerization, alkyl ether sulfates are one of the major surfactants necessary to provide for the stabilization of micelles. Traditionally, these sulfates have been based on alkylphenol ethoxylates (APEOs). Typically, emulsion polymerization uses two types of surfactants—one nonionic and the other anionic. Each provides separate stabilization mechanisms for the micelles, but the combination provides better stabilization, especially as temperature increases. The nonionic surfactants bestow a steric separation between micelle groups, while anionic surfactants yield a charged repulsion between the micelles. Nonionic surfactants generally perform well over a range of pH values, and they will usually foam less than anionic and cationic surfactants. However, nonionic surfactants may not lower the surface tension as well as anionic or cationic surfactants in complex coating formulations. There are nonionic polymeric fluorochemical surfactants that provide low surface tensions in organic coating systems. The lower the surface tension, the more effectively a coating wets, levels and spreads. Consequently, these are excellent wetting, leveling and flow control agents for a variety of waterborne, solvent borne and high solids coatings systems. Most of the fluoro-surfactants are soluble and compatible with most polymers and continue to be active throughout the drying or curing process. When used in waterborne systems, they tend to reduce the aqueous/organic interfacial tension and remain surface active in the organic portion of the polymer system. There is also an anionic fluoro-surfactant on the market based on ammonium salt, which is soluble in water.

Anionic surfactants carry a negative charge on the hydrophilic portion of the molecule. They are usually phosphates, sulfates and sulfonates. These surfactants may or may not contain an oxyethylene chain in their structure. Examples of anionic surfactants are sulfosuccinates, dioctyl sulfosuccinate (DOSS), polyether sulfates, polyether sulfonates, polyether phosphates, sodium lauryl sulfate and phosphate ester-modified alcohol-ethoxylates.

Surface-active phosphate esters are a class of anionic surfactants prepared by the reaction of alcohols with an activated phosphoric acid derivative—including phosphoric acid anhydrides and acid chlorides. Typically, phosphate ester commercial products are composed of a mixture of monoester, diester, free-phosphoric acid and free alcohol used in its preparation. The property of the final phosphate ester product is primarily defined by the starting alcohol used as well as on the composition of the four different species. Conversely, the property of the final phosphate product can be tailor-made by altering the alcohol used in the preparation as well as controlling the ratio of the four different components present in the final product. Phosphate ester surfactants are made in the free-acid form, but can also be neutralized to the salt form using any base including sodium hydroxide, potassium hydroxide, ammonium hydroxide or any organic amine.

Typically, the phosphate ester surfactants are added into the formulation during paint manufacture—added either in the grind or letdown depending upon the formulation. These additives have also been tested as post-paint formulation additives and have exhibited comparable properties. It has been speculated, and is the focus of a number of investigations, that use of the phosphate ester surfactant before the paint formulation stage—use of phosphate esters in emulsion polymerization as well as post polymerization stabilizer or additive in pigment dispersion—should only benefit the final property of the paint as well as reduce the detrimental effects of additional surfactants into the paint system.

Cationic surfactants carry a positive charge and quaternary ammonium compounds are the most common cationic surfactants. Compounds such as alkyl trimethyl ammonium chloride typify these surfactants.

The Hydrophilic Lipophilic Balance, HLB, system is a numbering system for rating the relative hydrophilic nature of a surfactant. The system is based on an arbitrary numerical scale where zero is assigned to a surfactant that is overwhelmingly hydrophobic and 20 is assigned to a surfactant that is overwhelmingly hydrophilic. The number assigned to the surfactant represents a measure of the balance between its hydrophilic and hydrophobic strengths. A surfactant with an HLB of 10 has an equal balance of oil-loving and water-loving groups.

Examples of initiators and chaser solutions useful in the polymerization process may include, but are not limited to, ammonium persulfate, sodium persulfate, azo initiators such as azoisobutyronitrile, redox systems such as sodium hydroxymethanesulfinate (sodium formaldehyde sulfoxylate; reducer) and t-butyl-hydroperoxide (oxidizer), and the like, and combinations thereof, typically in an aqueous solution. Either or both of these components can optionally contain an additional surfactant and/or a pH adjuster, if desired to stabilize the emulsion.

Examples of pH adjusters useful in the polymerization process may include, but are not limited to, ammonium hydroxide, sodium hydroxide, sodium carbonate, sodium bicarbonate, potassium hydroxide, potassium carbonate, potassium bicarbonate, ammonia, amines such as trimethylamine, triethylamine, dimethylaminoethanol, diethylaminocthanol, AMP-95 and the like, and combinations thereof. In certain cases, compounds that qualify as pH adjusters can be added for purposes other than adjusting pH, e.g., emulsion stabilization, and yet are still characterized herein as pH adjusters.

Polymer molecular weight control agents are designed to control (usually to limit) the molecular weight of a propagating polymer. While polymer molecular weight control agents may include things like radiation, they are typically molecules added to the polymerization mixture. Examples of polymer molecular weight control agents include, but are not limited to, chain transfer agents (CTAs), e.g., alkyl mercapto-esters such as isooctyl mercaptopropionate, alkyl mercaptans, and the like, and combinations thereof. Chain transfer agents typically operate as polymer molecular weight control agent molecules, for example, by catalytically or consumptively terminating a propagating polymer chain in a way that also initiates a newly propagating polymer chain. In this way, the amount of chain transfer agent(s) can be tailored to reduce the target polymer molecular weight in a set polymerization system, or alternately, in combination with calculation of the amount of initiator, can be calculated to target a particular average polymer molecular weight (e.g., within a given range) of a polymerization system.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all such modifications and embodiments, which would come within the spirit and scope of the present invention.

1. A substantially nonionic latex resin composition polymerized from a monomer mixture comprising at least one nonionic (meth)acrylate monomer, wherein the monomer mixture is substantially free of acid monomer or other monomers with anionic groups,
a polymerizable nonionic hydrophilic component, wherein the polymerizable nonionic hydrophilic component is present from about 1.0 wt. % to about 4.0 wt. %, wherein the polymerizable nonionic hydrophilic component comprises a polymerizable polyethylene glycol monomer or a polymerizable polypropylene glycol monomer, and
a nonionic surfactant ranging from about 4 wt. % to 8 wt. %, wherein the nonionic surfactant has a hydrophilic-lipophilic balance (HLB) value from about 14 to about 18,
wherein the weight percentages are without water.

2. The substantially nonionic latex resin composition of claim 1 is additionally polymerized with an anionic surfactant in a seeding amount ranging 0.01 wt. % to about 0.25 wt. % based on total monomer content.

3. The substantially nonionic latex resin composition of claim 1, wherein the monomer mixture comprises no acid monomer or other monomers with anionic groups.

4. The substantially nonionic latex resin composition of claim 1, wherein the acid monomer or other monomers with anionic groups are less than 0.25 wt. % of total monomer content.

5. The substantially nonionic latex resin composition of claim 1, wherein the polymerizable nonionic hydrophilic component is present from about 1.5 wt. % to about 3.5 wt. %.

6. (canceled)

7. The substantially nonionic latex resin composition of claim 1, wherein the polymerizable polyethylene glycol monomer is a methoxypolyethylene glycol methacrylate monomer.

8. The substantially nonionic latex resin composition of claim 1, wherein only nonionic surfactant is used in the polymerization to form micelles and the substantially nonionic latex resin.

9. A paint composition comprising a blend of the substantially nonionic latex resin composition of claim 1 and a cationic resin.

10. The paint composition of claim 9 further comprising a rust inhibitor.

11. The paint composition of claim 9, wherein the blend of the substantially nonionic resin and the cationic resin ranges from 80 wt. % cationic resin and 20 wt. % nonionic resin to 20 wt. % cationic resin and 80 wt. % nonionic resin,
wherein the wt. % of cationic resin and nonionic resins are dry weight.

12. The paint composition of claim 9, wherein the blend of the substantially nonionic resin and the cationic resin ranges from 70 wt. % cationic resin and 30 wt. % nonionic resin to 30 wt. % cationic resin and 70 wt. % nonionic resin,
wherein the wt. % of cationic resin and nonionic resins are dry weight.

13. The paint composition of claim 9, wherein the blend of the substantially nonionic resin and the cationic resin ranges from 60 wt. % cationic resin and 40 wt. % nonionic resin to 40 wt. % cationic resin and 60 wt. % nonionic resin,
wherein the wt. % of cationic resin and nonionic resins are dry weight.

14. The paint composition of claim 9, wherein the blend of the substantially nonionic resin and the cationic resin ranges from 55 wt. % cationic resin and 45 wt. % nonionic resin to 45 wt. % cationic resin and 55 wt. % nonionic resin,
wherein the wt. % of cationic resin and nonionic resins are dry weight.
